(19) United States
(12) Patent Application Publication
(10) Pub. No.: US 2025/0145905 A1
(43) Pub. Date: May 8, 2025

(54) NOVEL METHOD FOR REMOVING DEMULSIFIERS FROM A FEEDSTOCK

(71) Applicant: Neste Oyj, Espoo (FI)

(72) Inventor: Ronny WAHLSTRÖM, Porvoo (FI)

(73) Assignee: Neste Oyj, Espoo (FI)

(21) Appl. No.: 18/684,255

(22) PCT Filed: Aug. 23, 2022
(86) PCT No.: PCT/EP2022/073392

§ 371 Date: Feb. 16, 2024

(30) Foreign Application Priority Data
Aug. 24, 2021 (FI) 20215885

(51) Int. Cl. C11B 3/00

(52) U.S. Cl. CPC C11B 3/001

(57) ABSTRACT

The present disclosure relates to a novel method or process for removing or reducing demulsifiers from a feedstock.

### FIELD OF THE INVENTION

Present invention relates to the field of processing and purifying a feedstock. Specifically, the invention solves the problem of removing or reducing demulsifiers from a feedstock, where the demulsifiers have been used e.g. in a previous processing of the feedstock. The feedstock itself may be of any plant or animal origin and lipids therefrom. Present invention also relates to a purified feedstock obtainable by the method according to the invention.

### BACKGROUND OF THE INVENTION

U.S. Pat. No. 2,247,359 relates to a process of purifying vegetable and animal oils containing impurities, comprising the steps of mixing measured quantities of oil and acid to effect substantial reaction of the impurities with said acid, thereafter continuously advancing a relatively small stream of the mixture through a heating zone, continuously and rapidly heating the stream as it passes through said zone to a temperature sufficient to facilitate centrifugal separation and promptly centrifugally separating the foots from the neutral oil.

US2016145536 relates to corn oil as a possible feedstock and in one embodiment, an acid, such as phosphoric acid, may be added to the crude feedstock in the chemical refining unit with or without additional water. In such a process, the acid and water perform a similar function as in the degumming unit.

WO 2018/024728 relates to a method for purifying a feedstock acid aided heat treatment. The method appears to relate to the employment of the addition of a substance capable of forming a separate phase with impurities present in the feedstock.

Present invention provides for a much more efficient, simple, and effective procedure resulting in feedstocks essentially free of demulsifiers or with remarkably reduced amounts of demulsifiers.

### SUMMARY OF THE INVENTION

As discussed herein, present invention relates to a method of removing or reducing one or more demulsifying compounds from a feedstock.

Thus, the invention enables facile removal of demulsifiers used in the processing of a feedstock. Specifically, the invention provides for a method applicable in large industrial scale use by the use of a simple and effective method resulting in a very cost efficient procedure.

Essentially, the method may comprise the steps of:
a) providing a feedstock comprising lipids of plant or animal origin and one or more demulsifier,
b) optionally adding water to the feedstock in a),
c) adding an acid to the feedstock in a) or to the mixture in b) and optionally stirring the mixture at elevated temperature for a period of time,
d) adding a silica based compound to the mixture in c),
e) optionally, subjecting the mixture resulting from step d) to a drying step,
f) separating the silica based compound from the mixture obtained e),
g) removing and/or neutralising the acid remaining in step f), to obtain a feedstock substantially free of demulsifier.

In a further aspect, present invention relates to a method comprising the steps of:
a) providing a feedstock comprising lipids of plant or animal origin and one or more demulsifier,
b) optionally adding water in an amount of 1 wt % to about 5 wt % to the feedstock in a),
c) and characterised in adding acid in an amount of 0.5 wt % to about 5 wt % to the feedstock in a) or to the mixture in b) and optionally stirring the mixture at elevated temperature of 30° C. to about 200° C. for 30 seconds to about 1 h,
d) adding a silica based compound to the mixture in c),
e) optionally subjecting the mixture resulting from step d) to a drying step,
f) separating the silica based compound from the mixture obtained from step
d) or e),
g) removing and/or neutralising the acid remaining after step c), d), e) or f), to obtain a feedstock substantially free of demulsifier, wherein the acid is sulphuric acid (H₂SO₄), hydrochloric acid (HCl), nitric acid (HNO₃), phosphoric acid (H₃PO₄), boric acid (H₃BO₃), hydrofluoric acid (HF), hydrobromic acid (HBr), perchloric acid (HClO₄), or hydroiodic acid (HI), or methyl sulfonic acid (CH₃SO₃H), or any combinations or mixtures thereof.

Thus, in one aspect, present invention relates to removal or reduction of demulsifiers from a feedstock. The demulsifier may be any compound or compounds used in a processing of a feedstock. In a further aspect, the method of present invention not only removes the added demulsifier, but also the bulk of other impurities present in the feedstock such as e.g. metal impurities, phosphorous containing or nitrogen containing compounds.

Typically, the presence of the one or more demulsifiers in the feedstock to be purified in the method or process according to the invention may be up to about 0.8 wt % or about 0.4 wt %.

In another aspect, the demulsifiers may be any type of compound which is employed as an emulsion breakers, are a class of specialty chemicals used to separate emulsions, for example, water in oil. Demulsifiers may be used in any type of processing a feedstock in order to remove any type of undesired compounds from the feedstock which may be necessary for further use or processing of the feedstock.

The feedstock may be of any plant or animal origin and may thus be based on any parts, derivatives or products based on any plants or animals.

The acid may be any type of acid such as e.g. a mineral acid that may in principle be any mineral acid known in the art. There are several non-limiting examples of this such as e.g. sulphuric acid (H₂SO₄), hydrochloric acid (HCl), nitric acid (HNO₃), phosphoric acid (H₃PO₄), boric acid (H₃BO₃), hydrofluoric acid (HF), hydrobromic acid (HBr), perchloric acid (HClO₄), or hydroiodic acid (HI), or any combinations or mixtures thereof.

Other examples of acids that may be used is e.g. methyl sulfonic acid.

Another example may be e.g. ethyl sulfonic acid.

According to the invention, the silica based compound may in principle be any silicon based compound. In one aspect, the silica based compound may be any type of silica gel, which may be an amorphous and porous form of silicon dioxide (silica), consisting of an irregular tridimensional framework of alternating silicon and oxygen atoms with nanometer-scale voids and pores. The voids may contain water or some other liquids, or may be filled by gas or vacuum (also referred to as silica xerogel).

According to the process, the silica based compound may be removed or separated from the mixture once the heating step has been considered concluded or completed. Removal or separation of the silica based compound may be effected by filtration, and/or centrifugation and/or settling/sedimentation. In one aspect, removal of the silica based compound may be effected by decantation.

According to the invention, the process may include neutralization of the acid employed in the purification process. The process may alternatively comprise any other method for removing the acid used in the process. In yet another alternative, both a neutralization and other removal method may be employed. A non-limiting example may be washing the obtained feedstock with e.g. water or an aqueous solution. Neutralization may be performed by any known method in the art and may e.g. comprise addition of a suitable base/alkaline solution, such as e.g. addition of a NaOH solution.

The obtained purified feedstock may be essentially free of any demulsifiers or may contain a reduced amount of demulsifiers. Thus, the purified feedstock may be 100% free of any demulsifiers, or may contain less than e.g. about 20% demulsifiers, or less than about 15%, less than about 10%, less than about 5%, less than about 3%, less than about 1%, less than about 0.5%, or less than about 0.1% demulsifiers measured as wt %, based on the weight of the purified feedstock.

As also mentioned herein, present invention relates to a purified feedstock obtainable by the method according to the invention.

### Definitions

By the term “feedstock” is intended to mean any material based on or originating from any plant or animal origin. It may also refer to any material based on algae or bacteria or fungal material. The term may also specifically comprise any plant oils, plant fats, animal fats and animal oils, and mold oils, selected from e.g. rapeseed oil, canola oil, colza oil, tall oil, sunflower oil, corn oil, technical/distillers corn oil (TCO), soybean oil, hemp oil, olive oil, linseed oil, cottonseed oil, mustard oil, palm oil, palm effluent sludge (PES), arachis oil, castor oil, coconut oil, animal fats such as e.g. suet, tallow, blubber, recycled alimentary fats, starting materials produced by genetic engineering, and biological starting materials produced by microbes such as algae and bacteria and the likes or any combinations or mixtures thereof.

The term “Technical Corn Oil” (TCO) is used specifically to designate the corn oil extracted through the dry milling process. In the dry milling process, corn grains are cleaned and ground directly to obtain a fine corn flour. This flour is then mixed with water, enzymes and other ingredients (cooking and liquefaction) to convert starch into simple sugars, then into glucose (saccharification). This glucose is fermented to produce ethanol, which is then removed by distillation and purified by dehydration. The remaining stillage (called distillers grain) is then processed further to expel technical corn oil (generally called “distillers corn oil” in the United States) through centrifugation. Demulsifiers can be used to enhance separation of the TCO from the rest of the stillage.

The terminology “reduced” is intended to mean that a certain component is present in a lower amount in any material, such as e.g. a feedstock, in relation to its presence in any material prior to any processing or its presence in e.g. a feedstock used as a starting material or raw material in any process. A reduction may this be that one or more components are reduced by 100%, and thus is essentially completely removed, or reduced by at least about 70%, such as e.g. about 75%, such as e.g. about 80%, such as e.g. reduced by at least about 85%, such as e.g. 90%, such as e.g. at least about 95%, such as e.g. at least about 97%, such as e.g. at least about 98%, such as e.g. at least about 99%. Such percentages may be measured as weight % (wt %) or volume % (vol %) and in relation to the total weight of the demulsfiers present in the feedstock prior to the feedstock has gone through and been processed by the method according to the invention. In another aspect of the definition, the reduction is such that the amount of demulsifier is below what is analytically detectable or below e.g. 0.1 wt % based on the weight of the purified feedstock. In another aspect, the demulsifier is reduce by e.g. about 75% to about 80%.

The terminology “acid” is intended to mean any Lewis acid or any chemical compound capable of donating a proton ion. The acid may be a mineral acid or a non-mineral acid such as e.g. sulphuric acid (H₂SO₄), hydrochloric acid (HCl), nitric acid (HNO₃), phosphoric acid (H₃PO₄), boric acid (H₃BO₃), hydrofluoric acid (HF), hydrobromic acid (HBr), perchloric acid (HClO₄), or hydroiodic acid (HI), or e.g. methyl sulfonic acid (CH₃SO₃H), or any combinations or mixtures thereof. In one aspect, the invention relates to a so-called strong acids which dissociate completely in water. Strong acids may be e.g. HCl (hydrochloric acid), H₂SO₄ (sulfuric acid), HNO₃ (nitric acid), HBr (hydrobromic acid), HClO₄ (perchloric acid), HI (hydroiodic acid), p-toluenesulfonic acid, methanesulfonic acid or ethane sulfonic acid. However, any acid having a pKₐ value which is less than about −1 may be regarded as a strong acid (and as measured in either water or DMSO at 25° C.).

The terminology “silica based” compound is intended to mean any compound containing a silica atom. Such compounds may be silicon oxide based compounds such as e.g. silicone dioxide based compounds. Further examples are e.g. silicagels or silica xerogels in any form or configuration. Further non-limiting example is e.g. silica alumina gel. Several varieties of silica based compounds exist on the market such as e.g. Trisyl® etc. which are also included in the terminology.

The terminology “demulsifier” is intended to mean any agent capable of breaking an emulsion. Such agents may comprise one or more chemicals and may be a class of specialty chemicals used to separate emulsions, for example, water in oil. Such agent or agents may be e.g. an ethoxylated sorbitan, such as e.g. Polysorbate 20 (polyoxyethylene (20) sorbitan monolaurate), Polysorbate 40 (polyoxyethylene (20) sorbitan monopalmitate), Polysorbate 60 (polyoxyethylene (20) sorbitan monostearate), Polysorbate 80 (polyoxyethylene (20) sorbitan monooleate). The number 20 following the ‘polyoxyethylene’ part refers to the total number of oxyethylene —(CH₂CH₂O)— groups found in the molecule. The number following the ‘polysorbate’ part is related to the type of fatty acid associated with the polyoxyethylene sorbitan part of the molecule. Monolaurate is indicated by 20, monopalmitate is indicated by 40, monostearate by 60, and monooleate by 80. Other examples of demulsifiers are e.g. acid catalysed phenol-formaldehyde resins, base catalysed phenol-formaldehyde resins, epoxy resins, polyethyleneimines, polyamines, di-epoxides, polyols, dendrimer. These may be ethoxylated and/or propoxylated. In another aspect, the demulsifier may be any type of surfactant such as e.g. a sorbitan based compound. A non-limiting example is sorbitan monooleate or the likes.

### DETAILED DESCRIPTION OF THE INVENTION

As mentioned above, present invention relates to a method of removing or reducing the amount of one or more demulsifiers from a feedstock.

Present invention provides for a method enabling use of a feedstock for the preparation of other raw materials such as e.g. fuels and fine chemicals whereby demulsifiers are essentially removed or reduced in the purified feedstock. Present invention thus provides for a simple and effective processing of a feedstock for removal of demulsifiers and thus presents a method for use of renewable raw material. Present invention also provides for a simple yet very effective method for removal or reduction of demulsifiers present in a feedstock. This is beneficial from an economic point of view. The invention also provides for a method applicable to large scale removal or reduction of demulsifiers. The amount of demulsifier may be removed to such extent that the further processing of the feedstock is deemed acceptable or possible.

The inventors of present invention have surprisingly discovered that the employment of strong acids are particularly effective in reducing or removing the demulsifiers present in a feedstock.

In one aspect, the method according to the invention may comprise or consist of the steps of:
a) providing a feedstock comprising lipids of plant or animal origin and one or more demulsifier,
b) optionally adding water to the feedstock in a),
c) adding an acid to the feedstock in a) or to the mixture in b) and optionally stirring the mixture at elevated temperature for a period of time,
d) adding a silica based compound to the mixture in c),
e) optionally, subjecting the mixture resulting from step d) to a drying step,
f) separating the silica based compound from the mixture obtained e),
g) removing and/or neutralising the acid remaining in step f), to obtain a feedstock substantially free of demulsifier.

In one aspect, the invention relates to a method being performed or executed in sequential order, such as e.g. step a) is followed by step b), which is then followed by step c) etc.

In a further aspect, the invention relates to a method wherein there are no operations or process steps in between one or more of the method steps as disclosed herein.

The feedstock according to the invention may in principle be any material based on or originating from any plant or animal origin. Thus, the feedstock according to the invention may be a feedstock used as a starting or raw material for the further production of any type of fuel or fuel component and may this serves as a raw material/starting material for the production of renewable fuel. The feedstock may also be a feedstock for the production of any type of fine chemicals. Thus, the feedstock may be also be based on any algae or bacteria or fungal material. Non-limiting examples may be any plant oils, plant fats, animal fats and animal oils, and mold oils, selected from e.g. rapeseed oil, canola oil, colza oil, tall oil, sunflower oil, corn oil, technical/distillers corn oil or any fractions thereof, soybean oil, hemp oil, olive oil, linseed oil, cottonseed oil, mustard oil, palm oil, palm effluent sludge (PES), arachis oil, castor oil, coconut oil, animal fats such as e.g. suet, tallow, blubber, recycled alimentary fats, used cooking oil, starting materials produced by genetic engineering, and biological starting materials produced by microbes such as algae and bacteria and the likes or any combinations or mixtures thereof.

As mentioned herein, the aim with the process is to remove or at least reduce the amount of any demulsifiers present in the feedstock. The demulsifiers may have typically been used in any previous processing of the feedstock.

In one aspect, the demulsifier may in principle be any type or agent or agents used to break an emulsion such that the components in the emulsion are separated. In one aspect, the demulsifier may be a polysorbate, i.e. an ethoxylated sorbitan, such as e.g. Polysorbate 20 (polyoxyethylene (20) sorbitan monolaurate), Polysorbate 40 (polyoxyethylene (20) sorbitan monopalmitate), Polysorbate 60 (polyoxyethylene (20) sorbitan monostearate), Polysorbate 80 (polyoxyethylene (20) sorbitan monooleate).

Alternatively, the demulsifier may be any type of surfactant such as e.g. a sorbitan based compound and e.g. sorbitan monooleate.

According to the process, the provided feedstock comprising one or more demulsifiers, is optionally contacted with water. This operation is exemplified in step b) of the process. The amount of added water in step b) is in e.g. an amount of about 1 wt % to about 5 wt %, and preferably about 2 wt % based on the weight of the feedstock. Contacting may be made with any suitable technique such as e.g. mechanical stirring, or agitation etc.

Optionally, the contacting with water in step b) may include allowing the contacting to proceed during a certain period of time. For example, the period of time in question may be e.g. between about 30 seconds to about 1 h, such as e.g. about 30 minutes, such as e.g. about 20 minutes, such as e.g. about 15 minutes, such as e.g. about 10 minutes, such as e.g. about 5 minutes, such as e.g. about 3 minutes, such as e.g. about 1 minute.

In one aspect, the period of time may be about 15 minutes and may include mechanical stirring.

Optionally, the contacting with water in step b) may include heating of the mixture. Heating may include heating to any temperature above ambient temperature. In one aspect, the temperature may be between about 30° C. to about 200° C., such as e.g. about 40° C., such as e.g. about 50° C., such as e.g. about 60° C., such as e.g. about 70° C., such as e.g. about 80° C., such as e.g. about 90° C., such as e.g. about 100° C., such as e.g. about 110° C., such as e.g. about 130° C., such as e.g. about 150° C., such as e.g. about 170° C., such as e.g. about 200° C.

In one aspect, the temperature is e.g. about 80° C.

Once the feedstock has been provided and contacted with water, optionally heated for a specified period of time as mentioned above, said feedstock is then mixed or contacted with an acid or acidic compound (which may be in step c) of the process). According to the invention, the acid may in principle be any type of Lewis acid or compound capable of donating or liberating a hydrogen ion. Non-limiting examples are e.g. any type of mineral acid, such as e.g. sulphuric acid (H₂SO₄), hydrochloric acid (HCl), nitric acid (HNO₃), phosphoric acid (H₃PO₄), boric acid (H₃BO₃), hydrofluoric acid (HF), hydrobromic acid (HBr), perchloric acid (HClO₄), or hydroiodic acid (HI), or any mixtures thereof.

In one aspect, the acid has a pKₐ (measured in water or DMSO at 25° C.) of −1 or less, such as e.g. −2 or less etc.

In a further aspect, the acid may be e.g. sulphuric acid (H₂SO₄), hydrochloric acid (HCl), nitric acid (HNO₃), hydrobromic acid (HBr), perchloric acid (HClO₄), or hydroiodic acid (HI), methanesulfonic acid, ethanesulfonic acid or any mixtures thereof.

In one aspect, the mineral acid is sulphuric acid (H₂SO₄).

However, the acid according to the invention may also be any other acid, other than a mineral acid, such as e.g. any type of organic acid. Further non-limiting examples may be e.g. methyl sulfonic acid (CH₃SO₃H) or ethyl sulphonic acid (CH₃CH₂SO₃H).

In one aspect, the acid may be methyl sulfonic acid (CH₃SO₃H).

In one aspect, the acid is added in an amount of about 0.5 wt % to about 5 wt %, preferably about 1 wt % or about 2 wt %, based on the content of the weight of the feedstock.

According to the process, the acid added to the feedstock may in principle be in any concentration, such as e.g. about at least about 60 vol %, such as e.g. at least about 70 vol %, such as e.g. at least about 80 vol %, such as e.g. at least about 85 vol %, such as e.g. at least about 90 vol %, such as e.g. at least about 95 vol %, such as e.g. at least about 96 vol %, such as e.g. at least about 97 vol %, such as e.g. at least about 98 vol %, or such as e.g. at least about 99 vol %, or such as e.g. at least about 99.5 vol %. The acid may be provided as an aqueous solution in the given concentrations.

The acid may be mixed or contacted with the feedstock by mechanical stirring or agitation.

The stirring or contacting with the acid may proceed for a period of time of about between about 30 seconds to about 1 h, such as e.g. about 30 minutes, such as e.g. about 20 minutes, such as e.g. about 15 minutes, such as e.g. about 10 minutes, such as e.g. about 5 minutes, such as e.g. about 3 minutes, such as e.g. about 1 minute.

In one aspect, the period of time may be about 5 minutes and may include mechanical stirring.

Optionally, once the acid is contacted with the feedstock, the resulting mixture may be heated. The heating may be up to any temperature at which the mixture may be processed during the conditions of the method, e.g. to such temperature that the resulting mixture is essentially in a liquid form. In one aspect, the temperature may be between about 30° C. to about 200° C., such as e.g. about 40° C., such as e.g. about 50° C., such as e.g. about 60° C., such as e.g. about 70° C., such as e.g. about 80° C., such as e.g. about 90° C., such as e.g. about 100° C., such as e.g. about 110° C., such as e.g. about 130° C., such as e.g. about 150° C., such as e.g. about 170° C., such as e.g. about 200° C.

In one aspect, the temperature is e.g. about 80° C.

As an optional feature, a silica based compound may be added to the process as illustrated in step d). The addition must provide for a contact between the silica based compound and the acid/feedstock mixture. Contacting or mixing may be effected by mechanical stirring or agitation.

In one aspect, the silica based compound is added simultaneously with the acid, or alternatively after addition of the acid and after the mixing and heating of the resulting mixture with the feedstock and the acid.

The silica based compound may in principle be any silicon oxide based compounds such as e.g. silicone dioxide based compounds. Further non-limiting examples are e.g. silica gels or silica xerogels in any form or configuration. Further non-limiting example according to the invention is e.g. silica alumina gel. Several varieties of silica based compounds exist on the market such as e.g. Trisyl® etc. which are also encompassed by present invention.

The silica based compound may be added in an amount of 0.5 wt % to about 5 wt %, preferably about 1 wt % or about 2 wt %, based on the content of the weight of the feedstock.

In one aspect, and optionally, the silica based mixture (mixed with the feedstock and the acid), may be mixed or otherwise contacted for any period of about 5 min to about 90 minutes, preferably about 20 min or about 60 min. Or alternatively for up to about 6 h, such as e.g. up to about 5 h, such as e.g. up to about 4 h, such as e.g. up to about 3 h, such as e.g. up to about 2 h, such as e.g. up to about 90 minutes, such as e.g. up to about 80 minutes, such as e.g. up to about 70 minutes, such as e.g. up to about 60 minutes, such as e.g. up to about 50 minutes, such as e.g. up to about 40 minutes, such as e.g. up to about 30 minutes, such as e.g. up to about 20 minutes, such as e.g. up to about 10 minutes, such as e.g. up to about 5 minutes. Preferably, the contacting which may be by e.g. mechanical stirring, the contacting time may be about 20 min.

The silica based mixture (mixed with the feedstock and the acid) may also be subjected to reduced pressure. The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar.

The silica based mixture (mixed with the feedstock and the acid) may also be heated. The heating may be in the range of in the range of about 30° C. to about 200° C., such as e.g. in the range of in the range of about 35° C. to about 150° C., such as e.g. in the range of in the range of about 40° C. to about 130° C., such as e.g. in the range of in the range of about 50° C. to about 120° C., such as e.g. in the range of in the range of about 60° C. to about 100° C., such as e.g. in the range of in the range of about 70° C. to about 90° C., or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C. Preferably, the heating is about 80° C.

In one aspect, present invention also relates to an optional step e). The optional step e) comprises a drying step of the mixture resulting from step d).

The drying step optionally following step d) may comprise treating the mixture resulting from step d) at an elevated temperature. Such temperature may be any temperature above ambient temperature, such as e.g. in the range of in the range of about 30° C. to about 200° C., such as e.g. in the range of in the range of about 35° C. to about 150° C., such as e.g. in the range of in the range of about 40° C. to about 130° C., such as e.g. in the range of in the range of about 50° C. to about 120° C., such as e.g. in the range of in the range of about 60° C. to about 100° C., such as e.g. in the range of in the range of about 70° C. to about 90° C., or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C.

In one aspect, the drying step may comprise treatment at a temperature of about 90° C. to about 110° C., preferably about 105° C.

The drying step optionally following step d) may also comprise treatment of the mixture and at reduced pressure. The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar, or alternatively at least at 90 mbar, such as e.g. at least 80 mbar, such as e.g. at least 70 mbar, such as e.g. at least 60 mbar, such as e.g. at least 50 mbar, such as e.g. at least 40 mbar, such as e.g. at least 30 mbar, such as e.g. at least 20 mbar, such as e.g. at least 10 mbar, such as e.g. at least 5 mbar, such as e.g. at least 1 mbar.

In one aspect, the reduced pressure may be about 50 mbar to about 100 mbar, or preferably about 80 mbar.

The drying step optionally following step d) may be conducted for any suitable period of time or until deemed sufficient to remove a desired amount of water or until the amount of water left in the mixture is deemed acceptable. Such period of time may be for a time period of about 5 min to about 90 minutes, preferably about 20 min or about 60 min, or preferably about 15 minutes. Alternatively for up to about 6 h, such as e.g. up to about 5 h, such as e.g. up to about 4 h, such as e.g. up to about 3 h, such as e.g. up to about 2 h, such as e.g. up to about 90 minutes, such as e.g. up to about 80 minutes, such as e.g. up to about 70 minutes, such as e.g. up to about 60 minutes, such as e.g. up to about 50 minutes, such as e.g. up to about 40 minutes, such as e.g. up to about 30 minutes, such as e.g. up to about 20 minutes, such as e.g. up to about 10 minutes, such as e.g. up to about 5 minutes.

In one aspect, the period of time may be during any time period of about 5 min to about 60 min, or preferably about 15 min or about 45 min.

According to the invention, the silica based compound may be removed or separated from the feedstock by any suitable method known in the art. In one aspect, the silica based compound is removed in step f), and thus separating the silica based compound from the mixture obtained from step d) or e).

Separation of the silica based compound may be conducted by filtration, sedimentation/settling, centrifugation, or decantation or any combinations thereof. Optionally, the removal of the silica based compound may be performed under vacuum or reduced pressure such as e.g. a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar, or alternatively at least at 90 mbar, such as e.g. at least 80 mbar, such as e.g. at least 70 mbar, such as e.g. at least 60 mbar, such as e.g. at least 50 mbar, such as e.g. at least 40 mbar, such as e.g. at least 30 mbar, such as e.g. at least 20 mbar, such as e.g. at least 10 mbar, such as e.g. at least 5 mbar, such as e.g. at least 1 mbar.

The acid added to the process may be removed from the treated mixture by any suitable means. This step may be illustrated by step g) according to the invention. In one aspect, the acid is removed by neutralization by addition of a basic/alkaline compound of solution. In another aspect, the acid is removed by washing the mixture with e.g. water or a suitable aqueous solution. In yet a further aspect, the acid is removed by both neutralization and washing in any order.

The neutralizing agent may in principle be any suitable base, such as e.g. NaOH, KOH, Ca(OH)₂ etc or an aqueous solution thereof. The aqueous solution may in principle have any concentration of the basic/alkaline compound to such an extent that the final water content does not result in an excessive amount of water to be removed further on in any following process. The concentration may be e.g. about 50 wt % or more, such as e.g. 60 wt % or more, such as e.g. 70 wt % or more, such as e.g. 80 wt % or more, etc.

According to the invention, the amount of demulsifier in the feedstock or feedstock matrix may be reduced by at least about 20 wt %, such as e.g. about 30 wt %, such as e.g. about 40 wt %, such as e.g. about 50 wt %, such as e.g. about 60 wt %, such as e.g. about 70 wt %, such as e.g. about 80 wt %, such as e.g. about 90 wt %, such as e.g. about 95 wt %, such as e.g. about 98 wt %, or at least essentially free of any demulsifiers in the feedstock or feedstock matrix in relation to the demulsifiers present in the feedstock prior to the processing according to the method according to the invention.

In one aspect, the amount of demulsifiers is removed to the extent that the amount is below what is possible to detect by any analytical method known in the art. In one aspect, the demulsifier is present in an amount of less than about 0.1 wt % after the feedstock has been purified according to the invention.

According to the invention, the method also enables reduction of phosphorous or phosphorous containing compounds, and/or any metals present in the feedstock prior to the processing/method according to the invention. According to one aspect of the invention, the amount of phosphorous or phosphorous containing compounds and metals are removed by at least 95%, such as e.g. at least 98% or e.g. at least 99% or more.

In one aspect, present invention also relates to a feedstock obtainable by the method/process according to the invention.

In yet a further aspect, present invention also relates to use of a feedstock obtainable by the method or process according to present invention for the preparation of fuel components or fine chemicals.

The advantage with present invention is that apart from being very effective and simple as well as being useful in large scale industrial production, is that the invention enables us of more challenging low-quality feedstocks, such as e.g. using TCO in higher amounts. The method may also be employed in respect of TCO-low-quality AF blends.

### EXAMPLES

In the following, the invention is illustrated by the following non-limiting example.

### Example 1

A typical treatment protocol for strong acid treatment is according to the steps:
1. Stir feed (100 g) with magnetic stirrer in round bottom flask at 80° C.
2. Add water (2 mL)
3. Stir 15 min at 80° C.
4. Add H₂SO₄ (95-97%, 1 g, 10.2 mmol, 0.56 mL)
5. Stir 5 min at 80° C.
6. Add amorphous silica absorbent (2 g)
6a. Optionally, stir 20 min at 80° C. at 800 mbar
6b. Optionally, stir 15 min at 105° C. at 80 mbar
7. Remove amorphous silica absorbent by filtration (2 μm) at 70° C. at vacuum by Buchner filtration.
8. Wash oil phase with water (2×20 ml) and separate water layer in separation funnel
9. Check that pH of last water wash is rather neutral (pH-above 3)
10. Optionally, Centrifuge the oil at 4400 rpm/50° C./20 min and separate any solids/water

In another example, the above protocol was followed and compared with methods not including strong acid treatment with the results as seen below:

| Treatment/sample | Polysorbate (wt-%) |
|---|---|
| TCO feed | 0.33 |
| Heat treatment | 0.33 |
| Strong acid treatment | <0.1 |
| 3-fold extraction with citric acid | 0.21 |
| solution (2000 mg/kg) | |
| Acid degumming | 0.27 |
| 0.45 μm membrane filtration at 80° C. | 0.32 |
| Pre-filtration with conventional filter | 0.33 |
| aid at 80° C. | |
| Pre-filtration with adsorptive filter aid | 0.28 |
| at 80° C. | |
| Pre-filtration with adsorptive filter aid | 0.19 |
| at room temperature | |
| Bleaching 1% adsorbent | 0.23 |

The results seen above clearly illustrates the superior results obtained by employment of treatment with strong acids.

1-19. (canceled)

20. A method for removing or reducing a demulsifier from a feedstock, the method comprising;
a) providing a feedstock containing lipids of plant or animal origin and at least one or more demulsifier, wherein the demulsifier is a polysorbate based compound;
b) optionally adding water to the feedstock in a);
c) adding acid to the feedstock in a) or to the feedstock with added water in b) to form a mixture, and optionally stirring the mixture at elevated temperature for a period of time;
d) adding a silica based compound to the mixture in c), wherein the silica based compound is a silicone dioxide based compound to form a silica mixture;
e) optionally subjecting the silica mixture resulting from step d) to a drying step;
f) separating the silica based compound from the silica mixture obtained from step d) or e); and
g) removing and/or neutralising acid remaining after step c), d), e) or f),
to obtain a feedstock substantially free of the demulsifier, or a feedstock containing a reduced amount of the demulsifier.

21. The method according to claim 20, wherein the feedstock is plant oils, plant fats, animal fats and animal oils, and mould oils, selected from rapeseed oil, canola oil, colza oil, tall oil, sunflower oil, soybean oil, hemp oil, olive oil, linseed oil, cottonseed oil, mustard oil, palm oil, palm effluent sludge (PES), technical corn oil (TCO) containing any fractions thereof, arachis oil, castor oil, coconut oil, animal fats, suet, tallow, blubber, recycled alimentary fats, starting materials produced by genetic engineering, and biological starting materials produced by microbes, algae and bacteria, or any combinations or mixtures thereof.

22. The method according to claim 20, wherein the acid has a pKₐ of less than about −1.

23. The method according to claim 20, wherein the acid is sulphuric acid (H₂SO₄), hydrochloric acid (HCl), nitric acid (HNO₃), phosphoric acid (H₃PO₄), boric acid (H₃BO₃), hydrofluoric acid (HF), hydrobromic acid (HBr), perchloric acid (HClO₄), or hydroiodic acid (HI), or methyl sulfonic acid (CH₃SO₃H), or any combinations or mixtures thereof.

24. The method according to claim 20, wherein the acid is sulphuric acid (H₂SO₄) or methyl sulfonic acid (CH₃SO₃H) or a mixture thereof.

25. The method according to claim 20, comprising:
conducting a heating at the elevated temperature in step c) for a period of time of about between about 30 seconds to about 1 h, including, but not limited to, heating for about 30 minutes, about 20 minutes, about 15 minutes, about 10 minutes, about 5 minutes, about 3 minutes, and/or about 1 minute, and wherein the heating is at any temperature at which the mixture is processed during conditions of the method, to such temperature that a resulting mixture is essentially in a liquid form, or temperature between about 30° C. to about 200° C., including, but not limited to about 40° C., about 50° C., about 60° C., about 70° C., about 80° C., about 90° C., about 100° C., about 110° C., about 130° C., about 150° C., about 170° C., and/or about 200° C.

26. The method according to claim 25, comprising:
conducting the heating at a reduced pressure of about 100 mbar to about 900 mbar, including, but not limited to, about 200 mbar to about 900 mbar, about 300 mbar to about 900 mbar, about 400 mbar to about 900 mbar, about 500 mbar to about 900 mbar, about 600 mbar to about 900 mbar, about 700 mbar to about 900 mbar, and/or about 800 mbar.

27. The method according to claim 20, wherein step c) is optionally followed by a drying step in step e), comprising one or more of the reaction conditions;
i) temperatures in a range of about 30° C. to about 200° C., including, but not limited to, in a range of about 35° C. to about 150° C., in a range of in about 40° C. to about 130° C., in a range of about 50° C. to about 120° C., in a range of about 60° C. to about 100° C., in a range of about 70° C. to about 90° C., and/or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., and/or about 200° C.,
ii) and/or reduced pressure, at a pressure of about 100 mbar to about 900 mbar, including, but not limited to, about 200 mbar to about 900 mbar, about 300 mbar to about 900 mbar, about 400 mbar to about 900 mbar, about 500 mbar to about 900 mbar, about 600 mbar to about 900 mbar, about 700 mbar to about 900 mbar, and/or about 800 mbar, or alternatively at least at 90 mbar, at least 80 mbar, at least 70 mbar, at least 60 mbar, at least 50 mbar, at least 40 mbar, at least 30 mbar, at least 20 mbar, at least 10 mbar, at least 5 mbar, and/or at least 1 mbar,
iii) and conducting the drying step for a period of time of about 5 min to about 90 minutes, about 20 min or about 60 min, about 15 minutes, or for up to about 6 h, including, but not limited to, up to about 5 h, up to about 4 h, up to about 3 h, up to about 2 h, up to about 90 minutes, up to about 80 minutes, up to about 70 minutes, up to about 60 minutes, up to about 50 minutes, up to about 40 minutes, up to about 30 minutes, up to about 20 minutes, up to about 10 minutes, and/or up to about 5 minutes.

28. The method according to claim 20, wherein the acid is added in an amount of about 0.5 wt % to about 5 wt %, and/or about 1 wt %, and/or about 2 wt %, based on a content of a weight of the feedstock.

29. The method according to claim 20, wherein the silica based compound is added in an amount of 0.5 wt % to about 5 wt %, and/or about 1 wt %, and/or about 2 wt %, based on a content of a weight of the feedstock.

30. The method according to claim 20, wherein the water added in step b) is in an amount of about 1 wt % to about 5 wt %, and/or 2 wt %.

31. The method according to claim 20, comprising:
removing the silica based compound in step f) by filtration, settling, centrifugation, decantation or any combinations thereof, and optionally under vacuum or reduced pressure.

32. The method according to claim 20, comprising:
removing the acid by water washing and/or neutralization in step g), by addition of a suitable base, NaOH or KOH or any aqueous solutions thereof, whereby a pH of the feedstock is set to a pH in range of about 3 to about 8, including, but not limited to, about 4, about 5, about 6, about 6.5, about 7, and/or about 7.5.

33. The method according to claim 20, comprising:
reducing the amount of demulsifier below levels detected by any analytical method, or present in an amount of less than about 0.1 wt %, or reduced by at least about 75% in relation to non-purified feedstock, including, but not limited to, at least 80%, at least 85%, at least 90%, at least 95%, at least 98% and/or at least 99% or more.

34. The method according to claim 20, wherein the amount of demulsifier present in the feedstock in step a) is from about 0.05 wt % to about 1 wt %, and/or about 0.4 wt % and/or about 0.8 wt % or more.

35. The method according to claim 20, wherein the demulsifier is an ethoxylated sorbitan, Polysorbate 20 (polyoxyethylene (20) sorbitan monolaurate), Polysorbate 40 (polyoxyethylene (20) sorbitan monopalmitate), Polysorbate 60 (polyoxyethylene (20) sorbitan monostearate), Polysorbate 80 (polyoxyethylene (20) sorbitan monooleate), or any type of a sorbitan based compound, and the silica based compound is a gel or silica xerogel in any form or configuration, or silica alumina gel.
